(19) United States
(12) Patent Application Publication
(10) Pub. No.: US 2015/0212350 A1
(43) Pub. Date: Jul. 30, 2015

(54) ADHESIVE LAYER-EQUIPPED TRANSPARENT SURFACE MATERIAL, DISPLAY DEVICE, AND PRODUCTION METHOD THEREFOR

(71) Applicant: Asahi Glass Company, Limited, Tokyo (JP)

(72) Inventors: Satoshi NIIYAMA, Tokyo (JP); Tateo BABA, Tokyo (JP); Naoko AOKI, Tokyo (JP)

(73) Assignee: Asahi Glass Company, Limited, Tokyo (JP)

(21) Appl. No.: 14/684,466

(22) Filed: Apr. 13, 2015

Related U.S. Application Data
(63) Continuation of application No. PCT/JP2013/077822, filed on Oct. 11, 2013.

(30) Foreign Application Priority Data
Oct. 19, 2012 (JP) 2012-232197

(51) Int. Cl. G02F 1/1333; B32B 7/12; B32B 37/24; B32B 38/10; B32B 37/00; B32B 38/00; B32B 38/04; B32B 3/08; B32B 37/12

(52) U.S. Cl. CPC G02F 1/1333; B32B 3/08; B32B 7/12; B32B 37/24; B32B 37/1292; B32B 37/0076; B32B 38/0004; B32B 38/04; B32B 38/10; B32B 2457/20; B32B 2037/243; B32B 2038/045; B32B 2307/412

(57) ABSTRACT

A transparent plate having an adhesive layer includes a transparent plate; a cover material formed on a peripheral portion of a surface of the transparent plate and having a notched portion on an upper side thereof; an adhesive layer formed in a region enclosed by the transparent plate and the cover material and on a partial region of the cover material such that the adhesive layer has a peripheral end face on the cover material, wherein the peripheral end face coincides with the position of the notched portion in a planar direction of the transparent plate; and a peelable protective film formed on the adhesive layer and having a peripheral end face such that the peripheral end face of the protective film is flush with the peripheral end face of the adhesive layer coinciding with the position of the notched portion.

### FIELD OF INVENTION

The present invention relates to a transparent plate having an adhesive layer suitably usable for protection of, e.g. the display panel of a display device, a display device having a display panel protected by the transparent plate, and a process for their production.

### BACKGROUND OF INVENTION

Heretofore, for protection of, e.g. the display panel of a display device, a transparent plate (protection plate), which is bondable to the display panel, has been utilized.

The transparent plate has an adhesive layer for bonding to a display panel (an object to be bonded) so as to be provided as a transparent plate having an adhesive layer with the adhesive layer covered with a protective film therein (see Patent Document 1 and Patent Document 2).

In each of Patent Document 1 and Patent Document 2, the transparent plate having an adhesive layer has a layer portion spreading over a wide range of the surface of the transparent plate and a seal portion enclosed by the periphery of the layer portion. For this reason, when the transparent plate having an adhesive layer is mounted to the display panel of a display device, the transparent plate having an adhesive layer is utilized so as to have the seal portion disposed outside of the image display region of a display device such that the interface between the seal portion and the layer portion is prevented from being externally visible.

### PRIOR ART DOCUMENTS

### Patent Documents

Patent Document 1: WO-A-2012-077726

Patent Document 2: WO-A-2012-077727

### SUMMARY OF INVENTION

### Technical Problem

In, e.g. a case where the transparent plate having an adhesive layer is utilized in a display panel having a frame of metal etc. disposed on a display screen side (hereinbelow, the frame on the display screen side will be called a front frame), the thick adhesive layer is formed in consideration of the thickness of the front frame because the transparent plate having an adhesive layer is bonded to the display panel through the opening of the front frame formed for making the display pixels visible. In order to provide the thick adhesive layer, the seal portion is required to have a sufficient height.

On the other hand, because the adhesive layer and the seal portion in combination have a larger area than the effective pixel region of a display panel and a smaller area than the opening of the front frame such that a reduction in the size of the display panel makes the size of the effective pixel region of a liquid crystal panel and the size of the opening of the front frame more approximate, it has been demanded that the transparent plate having an adhesive layer has a peripheral edge structure (i.e. a seal portion and so on) formed so as to have a narrow width.

It, however, has been difficult, in terms of, e.g. ensuring the strength required for the peripheral edge structure, to provide the seal portion with a sufficient height for ensuring the required thickness of the adhesive layer and make the peripheral edge structure narrower.

The present invention provides a transparent plate having an adhesive layer, a display device having a display panel protected by the transparent plate, and a process for their production, which are capable of forming a thick adhesive layer and of establishing a good display quality in the pixels in an outermost peripheral portion of the effective pixel region of a liquid crystal panel even in a case where the size of the effective pixel region and the size of the opening of the front frame are approximate.

### Solution to Problem

The transparent plate having an adhesive layer according to one mode of the present invention is characterized to include a transparent plate; a cover material formed on a peripheral portion of a surface of the transparent plate and having a notched portion on an upper side thereof; an adhesive layer formed in a region enclosed by the transparent plate and the cover material and on a partial region of the cover material such that the adhesive layer has a peripheral end face on the cover material, wherein the peripheral end face coincides with a position of the notched portion in a planar direction of the transparent plate; and a peelable protective film formed on the adhesive layer and having a peripheral end face such that the peripheral end face of the protective film is flush with the peripheral end face of the adhesive layer coinciding with the position of the notched portion.

The transparent plate having an adhesive layer according to another mode of the present invention is characterized to include a transparent plate; a light-shielding printed portion formed on a peripheral portion of a surface of the transparent plate; a cover material formed on the light-shielding printed portion; an adhesive layer made of a homogenous material, formed in a region enclosed by the transparent plate and the cover material and on a partial region of the cover material without having a gap with the cover material; a peelable protective film formed on the adhesive layer; and the cover material and the light-shielding printed portion having inner end faces, respectively, such that the inner end face of the cover material is formed on the outer side of the inner end face of the light-shielding printed portion by a distance of from d to 3d in a planar direction of the transparent plate wherein the adhesive layer has a thickness of d.

The process for producing a transparent plate having an adhesive layer according to one mode of the present invention is characterized to include a step of laminating a cover material on a peripheral portion of a surface of a transparent plate; a step of forming a seal portion on the cover material; a step of supplying a curable resin composition to a region enclosed by the surface of the transparent plate, the cover material and the seal portion; a step of laminating a protective film on the curable resin composition; a step of curing the curable resin composition to form an adhesive layer after laminating the protective film thereon; and a step of cutting off at least one part of a peripheral portion of the protective film and at least one part of a peripheral portion of the adhesive layer and removing at least one part of the seal portion.

The process for producing a display device according to one mode of the present invention is characterized to include a step of laminating a cover material on a peripheral portion of a surface of a transparent plate; a step of forming a seal portion on the cover material; a step of supplying a curable resin composition to a region enclosed by the surface of the transparent plate, the cover material and the seal portion; a step of laminating a protective film on the curable resin composition; a step of curing the curable resin composition to form an adhesive layer after laminating the protective film thereon; a step of cutting off at least one part of a peripheral portion of the protective film and at least one part of a peripheral portion of the adhesive layer and removing at least one part of the seal portion; a step of peeling the protective film after removing the at least one part of the seal portion; and a step of carrying out bonding such that a display panel is brought into contact with the adhesive layer with the protective film peeled therefrom.

### Advantageous Effects of Invention

In accordance with the present invention, it is possible not only to form a thick adhesive layer but also to obtain a good display quality in the pixels in an outermost peripheral portion of the effective pixel region of a liquid crystal panel, such as a liquid crystal panel, even in a case where the size of the effective pixel region and the size of an opening of the front frame are closed to each other.

### BRIEF DESCRIPTION OF DRAWINGS

FIGS. 1(a) and (b) are schematic cross-sectional views illustrating an example of the transparent plate having an adhesive layer according to the present invention, FIG. 1(a) being a general view while FIG. 1(b) being an enlarged view showing a peripheral portion and its vicinity.

FIG. 2 is a schematic cross-sectional view illustrating an example of the protective film utilized in the transparent plate having an adhesive layer illustrated in FIGS. 1(a) and (b).

FIG. 3 is a cross-sectional view explaining an example of a semi-product at a stage of an example of the process for producing the transparent plate having an adhesive layer according to the present invention.

FIG. 4 is a cross-sectional view explaining a step in an example of the process for producing the transparent plate having an adhesive layer.

FIG. 5 is a cross-sectional view explaining a step in the example of the process for producing the transparent plate having an adhesive layer.

FIG. 6 is a cross-sectional view explaining a step in the example of the process for producing the transparent plate having an adhesive layer.

FIG. 7 is a cross-sectional view explaining a step in the example of the process for producing the transparent plate having an adhesive layer.

FIG. 8 is a cross-sectional view explaining a step in the example of the process for producing the transparent plate having an adhesive layer.

FIG. 9 is a plan view explaining a step in the example of the process for producing the transparent plate having an adhesive layer.

FIG. 10 is a cross-sectional view explaining a step in the example of the process for producing the transparent plate having an adhesive layer.

FIG. 11 is a cross-sectional view explaining a step in the example of the process for producing the transparent plate having an adhesive layer.

FIG. 12 is a cross-sectional view explaining a step in the example of the process for producing the transparent plate having an adhesive layer.

FIG. 13 is a cross-sectional view explaining a step in an example of the process for producing the transparent plate having an adhesive layer.

FIG. 14 is a cross-sectional view explaining a step in the example of the process for producing the transparent plate having an adhesive layer.

FIG. 15 is a cross-sectional view explaining a step in the example of the process for producing the transparent plate having an adhesive layer.

FIG. 16 is a cross-sectional view explaining a step in the example of the process for producing a display device.

FIG. 17 is a perspective view explaining an example of the transparent plate having an adhesive layer.

FIG. 18 is a perspective view explaining a step in the example of the process for producing the display device.

FIG. 19 is a cross-sectional view illustrating an example of the display device utilizing the transparent plate having an adhesive layer illustrated in FIGS. 1(a) and (b).

FIG. 20 is an enlarged cross-sectional view illustrating a portion of the example of the display device utilizing the transparent plate having an adhesive layer illustrated in FIGS. 1(a) and (b).

FIG. 21 is a cross-sectional view explaining a step in a different example of the process for producing the transparent plate having an adhesive layer.

FIG. 22 is a cross-sectional view explaining a step in the different example of the process for producing the transparent plate having an adhesive layer.

FIG. 23 is a cross-sectional view explaining a step in the different example of the process for producing the transparent plate having an adhesive layer.

FIG. 24 is a cross-sectional view explaining a step in the different example of the process for producing the transparent plate having an adhesive layer.

FIG. 25 is a cross-sectional view explaining a step in the different example of the process for producing the transparent plate having an adhesive layer.

FIG. 26 is a schematic cross-sectional view illustrating a second example of the protective film.

FIG. 27 is a schematic cross-sectional view illustrating a third example of the protective film.

### DETAILED DESCRIPTION OF INVENTION

In Description, the wording “transparent” means a state where a display image on a display panel can be partly or entirely visible through a surface material without being subjected to optical distortion after the surface material is bonded to the display screen of the display panel so as to have no gap therebetween through an adhesive layer. In other words, even if the surface material has a low visible light transmittance because light entering the surface material from the display panel is partly absorbed or reflected by the surface material or is subjected to an optical phase change, the “transparent” state is established as long as a display image on the display panel can be visible through the surface material without being subjected to optical distortion. And the wording “(meth)acrylate” means an acrylate or a methacrylate.

### <Transparent Plate Having Adhesive Layer>

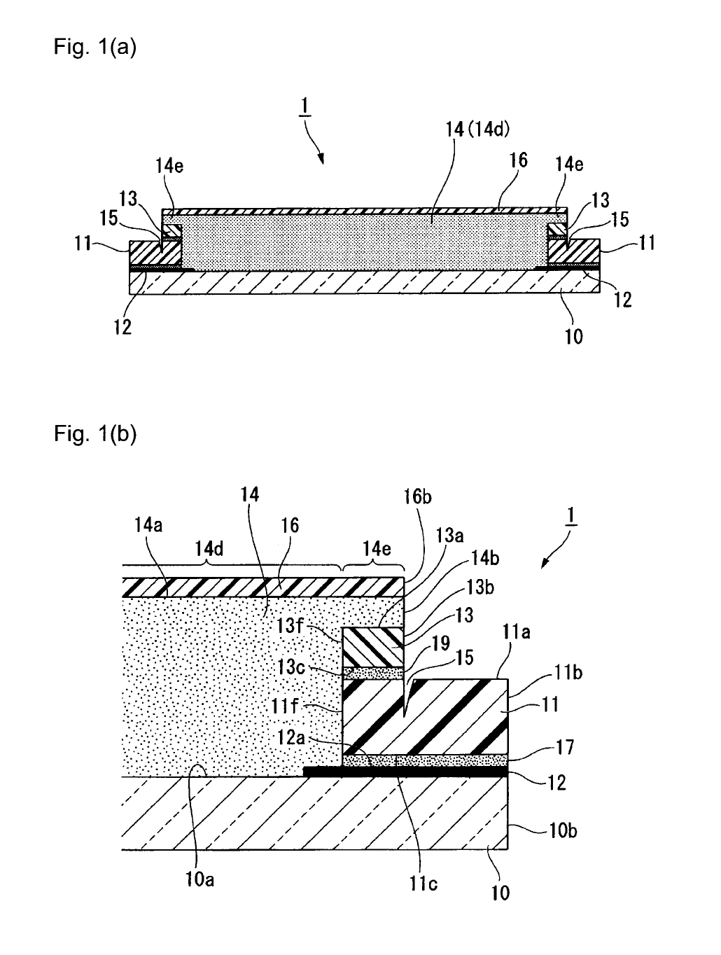

FIG. 1(a) and (b) are schematic cross-sectional views illustrating an example of the transparent plate having an adhesive layer of the present invention, FIG. 1(a) being a general view while FIG. 1(b) being an enlarged view showing a peripheral portion and its vicinity.

The transparent plate having an adhesive layer 1 includes a protective plate (i.e. transparent plate) 10, a light-shielding printed portion 12 disposed at a peripheral portion of the surface of the protective plate 10, a cover material 11 at a peripheral portion of the surface of the protective plate 10 where the light-shielding printed portion (i.e. light-shielding portion) 12 is disposed, an intermediate material 13 disposed on a surface of the cover material 11 opposite to the protective plate 10 (upper side 11 a in FIG. 1(b)), an adhesive layer 14 formed on the surface of the protective plate 10 where the light-shielding printed portion 12 is disposed, and a peelable protective film 16 (so-called protective material) covering the surface of the adhesive layer 14.

A display device can be produced by bonding the transparent plate having an adhesive layer 1 to a display panel after peeling the protective film 16.

### (Protective Plate)

The protective plate 10 is provided on the image display side of a display panel described later, to protect the display panel. The protective plate 10 may, for example, be a glass plate or a transparent resin plate. A glass plate is most preferred not only from the viewpoint that the transparency is high to emission light or reflection light from a display panel but also from the viewpoint that it has a light resistance, a low birefringence, a high planarity, a surface-scratching resistance and a high mechanical strength. A glass plate is preferred also from the viewpoint that it permits light to sufficiently pass therethrough to cure a photocurable resin composition in a production process described later.

As the material for the glass plate, a glass material, such as soda lime glass, may be mentioned, and less bluish highly transparent glass having a lower iron content (also called white plate glass) is more preferred. In order to increase the safety, tempered glass may be used as the surface material. Especially when a thin glass plate is to be used, it is preferred to employ a chemically tempered glass plate. As the material for the transparent resin plate, a resin material having a high transparency (such as polycarbonate or polymethyl methacrylate) may be mentioned.

To the protective plate 10, surface treatment may be applied in order to improve the interfacial adhesion to the adhesive layer 14. The method for such surface treatment may, for example, be a method of treating the surface of the protective plate 10 with a silane coupling agent, or a method of forming a thin film of silicon oxide by oxidation flame by means of a flame burner.

To the protective plate 10, an antireflection layer may be provided on the surface opposite to the surface with the adhesive layer 14 formed thereon, in order to increase the contrast of a display image. Further, depending upon a particular purpose, the protective plate 10 may be partly or entirely colored, the surface of the protective plate 10 may be partly or entirely made to have a frosted glass state to scatter light, or the protective plate 10 may partly or entirely have fine irregularities, etc. formed to refract or reflect transmitted light. Otherwise, a colored film, a light scattering film, a photorefractive film, a light reflecting film, etc. may be affixed on part of the surface or the entire surface of the protective plate 10.

It is preferred that the protective plate 10 be formed in a rectangular shape so as to correspond to the outer shape of a display device. Depending on the outer shape of a display device, the protective plate may be also formed in such a shape to contain a curved part in its outer shape so as to cover the entire display side of the display panel. The protective plate 10 may have a size properly set so as to correspond to the outer shape of a display device. The protective plate 10 has a thickness preferably from 0.5 to 25 mm in the case of a glass plate from the viewpoint of mechanical strength and transparency. In applications for television receivers, PC displays, etc. to be used indoors, the thickness is preferably from 1 to 6 mm from the viewpoint of reducing the weight of a display device, and in applications for public displays to be installed outdoors, it is preferably from 3 to 20 mm. In a case where chemically tempered glass is to be used, the thickness of the glass is preferably from about 0.5 to 1.5 mm from the viewpoint of the strength. In the case of a transparent resin plate, the thickness is preferably from 2 to 10 mm.

### (Light-Shielding Printed Portion)

The light-shielding printed portion (i.e. light-shielding portion) 12 shields wiring members etc. connected to a display panel, so that other than the image display region of a display panel described later is not visible from the side of the protective plate 10. The light-shielding printed portion 12 may be disposed on the surface of the protective plate 10 where the adhesive layer 14 is formed or on the opposite surface. From the viewpoint of reducing a parallax between the light-shielding printed portion 12 and the image display region, the light-shielding printed portion is preferably disposed on the surface of the protective plate where the adhesive layer 14 is to be disposed. In a case where the protective plate 10 is a glass plate, it is preferred to use ceramic printing so that the light-shielding printed portion 12 contains a black pigment, whereby the light shielding property becomes high.

In a case where a display panel is configured to have the wiring members etc. invisible from an observation side of the display panel or concealed by another member, such as the casing of the display device, or a case where the transparent plate having an adhesive layer is bonded to another bonded member other than a display panel, the protective plate 10 may have no light-shielding printed portion.

### (Cover Material 11)

The cover material 11 is a film made of e.g. a resin, which may be a film made of a polyester-based resin, such as polyethylene-terephthalate (hereinbelow, referred to as PET). The cover material 11 may be formed in, e.g. a band shape having a certain width.

The cover material 11 may have a thickness set at 35 to 200 μm for example. When the thickness is at least 35 μm, it is possible not only to secure the function of protecting the protective plate 10 and the light-shieling printed portion 12 from a cutting blade (described later) but also to be capable of providing the thick adhesive layer 14.

When the thickness is at most 200 μm, it is possible to reduce the entire thickness of the transparent plate having an adhesive layer 1.

The cover material 11 may be formed in a frame shape extending along a peripheral portion 10b of the protective plate 10. For example, when the protective plate 10 is formed in a rectangular frame shape in plan view, the cover material may be formed in a rectangular frame shape having the same outline as the protective plate 10 (see FIG. 17).

Even if the protective plate 10 is broken, the provision of the cover material 11 can more effectively prevent fragments of the protective plate 10 from scattering. As shown in FIG. 1(b), the cover material 11 has a notched portion 15 formed in the upper side 11a so as to coincide with peripheral end faces 16b and 14b of the protective film 16 and the adhesive layer 14 described later in terms of positioning in plan view. For example, when the peripheral end faces 16b and 14b are rectangular in plan view (see FIG. 17), the notched portion 15 may be rectangular in plan view so as to have the same size as the peripheral end faces 16b and 14b.

The notched portion 15 is a cut mark formed by the cutting blade 7 (see FIG. 14), and the cut mark may have a depth of at least 1 μm and of less than the thickness of the cover material 11.

Although the notched portion 15 is shown to be formed in a V-character shape in section in FIG. 1(b), the cross-sectional shape is not limited to this shape and may be a desired shape, such as a rectangular shape or a semi-circular shape. Further, the notched portion 15 may be configured such that both inner sides of the notch are close to each other or brought into contact with each other so as to substantially close the notched portion.

The notched portion may be formed at a position outwardly away from an inner peripheral end face 11f (right of center in FIG. 1(b)) by a distance of at least 0.2 mm and inwardly away from a peripheral end face 11b (outer peripheral end face) (left of center in FIG. 1(b)) by a distance of at least 0.2 mm.

The cover material 11 is bonded to an upper side of the protective plate 10 (specifically upper side 12a of the light-shielding printed portion 12) through an adhesive layer for the cover material 17 disposed on a lower side 11c of the cover material. The cover material 11 is disposed between the protective plate 10 and an outer region 14e of the adhesive layer 14 (i.e. the peripheral end face 14b and its close region).

The cover material 11 has an inner end face located at a position outwardly apart from an inner end face of the light-shielding printed portion 12 by a certain distance. The certain distance is, for example, preferably a length of from d to 3d when the adhesive layer 14 described in detail later has a thickness of d. This arrangement can provide a narrow peripheral structure with the cover material 11 and the intermediate material 13 being invisible from outside by the light-shielding printed portion 12.

Thus, it is possible to establish a good display quality in the pixels in an outermost peripheral portion of an effective pixel region.

Although the cover material 11 is disposed in a band-like region having a certain width and starting at the peripheral end face 10b of the protective plate 10 in the shown example, the cover material 11 is not limited to be disposed in such a location and may be disposed at a position inwardly away from the peripheral end face 10b.

### (Intermediate Material 13)

The intermediate material 13 is a film made of e.g. a resin, which may be a film made of a polyolefin-based resin, such as polyethylene or polypropylene, and be relatively flexible and easy to be notched by the cutting blade 7 described later. The intermediate material 13 may be formed in, e.g. a band shape having a certain width. The intermediate material 13 may have a thickness of, e.g. from 10 to 100 μm. The intermediate material 13 has a peripheral end face 13b located more inwardly than the peripheral end face 10b of the protective plate 10 in plan view.

For example, when the protective plate 10 is rectangular, the intermediate material 13 may be formed in a smaller rectangular frame shape than the outer size of the protective plate 10 in width and longitudinal directions (see FIG. 17). In the example shown in FIGS. 1(a) and (b), the intermediate material 13 has an inner peripheral end face 13f coinciding with the inner peripheral end face 11f of the cover material 11 in terms of positioning in planar view.

The intermediate material 13 is bonded to the upper side 11a of the cover material 11 through an adhesive layer for the intermediate material 19 disposed on a lower side 13c of the intermediate material. The adhesive layer for the intermediate material 19 may be a self-adhesive layer monolithically molded along with the intermediate material 13 by e.g. a coextrusion method.

The intermediate material 13 is disposed between the outer region 14e of the adhesive layer 14 and the upper side 11a of the cover material 11, and the intermediate material 13 may have a side 13a surface-roughened to improve the adhesiveness with a portion of the adhesive layer 14 in the outer region 14e.

### (Adhesive Layer)

The adhesive layer 14 is a layer made of a transparent resin formed by curing a liquid layer portion-forming curable resin composition described later (hereinbelow, referred to as the first composition).

The adhesive layer 14 has a shearing modulus of preferably from 10³ to 10⁷ Pa, more preferably from 10⁴ to 10⁶ at 25° C. The shearing modulus is particularly preferably from 10⁴ to 10⁵ Pa in order to force voids to disappear in a shorter period of time during bonding. When the shearing modulus is at least 10³ Pa, the adhesive layer 14 can maintain its shape. In this case, even when the adhesive layer 14 is relatively thick, the entire adhesive layer 14 can maintain a uniform thickness, and voids are less likely to be formed at the interface between the adhesive layer 14 and a display panel when the transparent plate having an adhesive layer 1 is bonded to the display panel. Further, when the shearing modulus is at least 10⁴ Pa, the adhesive layer 14 can be readily suppressed from being deformed when peeling the protective film as described later. When the shearing modulus is at most 10⁷ Pa, the adhesive layer 14 can show a good adhesion when being bonded to a display panel. Because the molecular mobility of the resin material constituting the adhesive layer 14 is relatively high, the volume of voids is easily decreased due to the differential pressure between the pressure in the voids (pressure kept in a reduced state) and the pressure exerted to the adhesive layer 14 (i.e. atmospheric pressure) when the transparent plate having an adhesive layer 1 is bonded to a display panel, followed by being returned to a state under atmospheric pressure. Further, the gas in voids having a decreased volume dissolves in the adhesive layer 14 and is readily absorbed thereinto.

The adhesive layer 14 has a thickness of preferably from 0.1 to 2 mm, more preferably from 0.2 to 1.6 mm. When the adhesive layer 14 has a thickness of at least 0.1 mm, a seal portion can be formed on an upper side of a laminate formed by the cover material and the intermediate material such that the adhesive layer 14 is readily formed so as to have a uniform thickness. It should be noted that the thickness of the adhesive layer 14 referred to herein means the thickness of the adhesive layer from a side in contact with the protective plate 10 to a side with the protective film 16 affixed thereto. Further, in the process for producing a display device according to this embodiment, even if a foreign matter not exceeding the thickness of the adhesive layer 14 is included between the display panel and the transparent plate having an adhesive layer 1, the thickness of the adhesive layer 14 will not be substantially changed, and an influence over the optical transparency is little. When the thickness of the adhesive layer 14 is at most 2 mm, voids are less likely to remain in the adhesive layer 14, and the entire thickness of the display device will not be unnecessarily thick. As the method for adjusting the thickness of the adhesive layer 14, a method for controlling the supply amount of the first composition in the form of liquid supplied on the protective plate 10 as well as controlling the thickness of the seal portion (described later) may be mentioned.

As shown in FIG. 1(b), the adhesive layer 14 is formed so as to have a certain thickness not only in a region inside the intermediate material 13 but also on the upper side 13a of the intermediate material 13 in plan view. In other words, the adhesive layer 14 includes an inner region 14d formed in the region inside the intermediate material 13 and having such a certain thickness, and the outer region 14e formed so as to extend outwardly from a peripheral end face of the inner region 14d along the upper side 13a of the intermediate material 13.

The inner region 14d and the outer region 14e are integrally formed and both regions have upper sides flush with each other.

The adhesive layer 14 is made of the homogenous composition without having any boundary, so as to have no gap with the cover material 11. Thus, if the protective plate 10 is broken, fragments of the protective plate can be more effectively suppressed from scattering.

### (Protective Film)

The protective film 16 is one that protects the surface of the adhesive layer 14 and is used just before the transparent plate having an adhesive layer 1 is bonded to a display panel.

### FIRST EXAMPLE

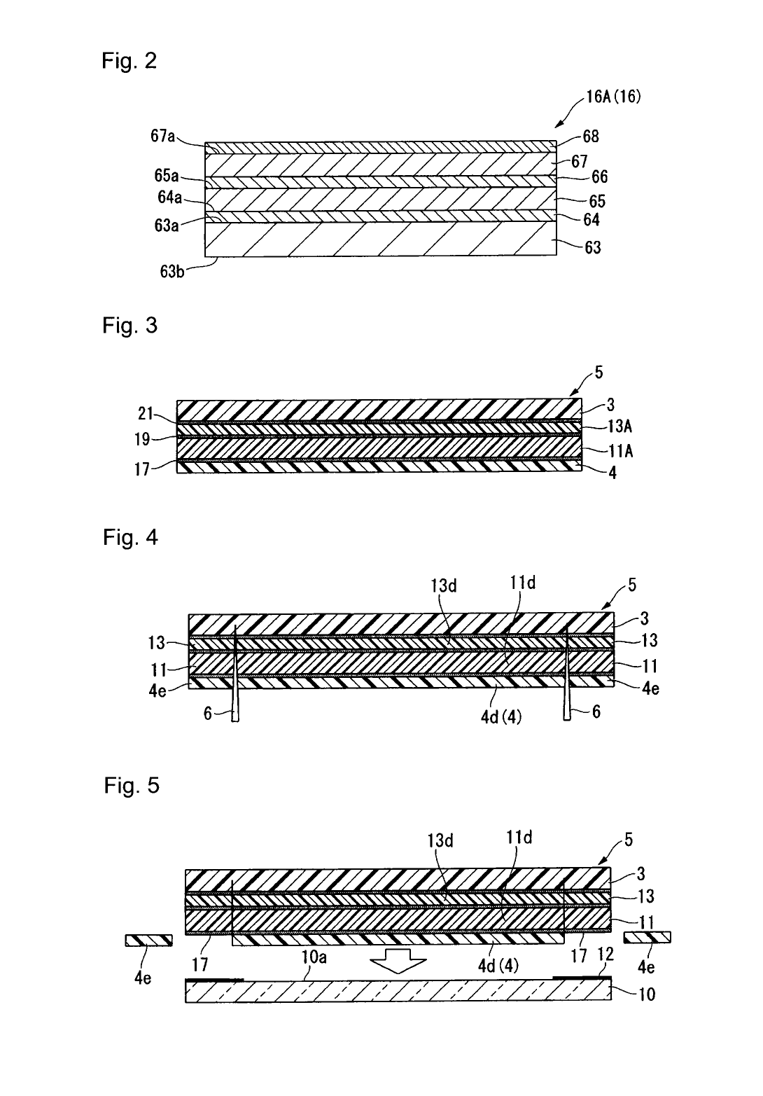

FIG. 2 is a schematic cross-sectional view illustrating an example of the protective film 16 (16A).

The protective film 16 includes a first support material 63, a barrier layer 64 disposed on the entire region of an upper side 63a of the first support material, a second support material 65 laminated on an upper side 64a of the barrier layer 64, a third support material 67 laminated on an upper side 65a of the second support material 65 through a bonding layer 66, and a slightly-adhesive layer 68 disposed on an upper side 67a of the third support material 67.

The first support material 63 is one which has a lower side 63b brought into contact with the adhesive layer 14, and which is preferably a film made of a resin, such as a polyethylene, a polypropylene or a fluorinated resin. In particular, polyolefin-based resin (such as a polyethylene resin or a polypropylene resin) is preferred because its use facilitates peeling from the adhesive layer 14.

Although the preferred thickness of the first support material 63 may vary depending upon the material to be used, in a case where a relatively flexible film mode of e.g. a polyethylene or polypropylene is to be used, the thickness is preferably from 10 to 100 μm. When the thickness is at least 10 μm, it is possible to prevent the protective film 16 from being excessively deformed at the time of peeling the protective film 16 from the adhesive layer 14. When the thickness is at most 100 μm, the protective film 16 is likely to flex at the time of peeling such that the peeling operation becomes easier.

The lower side 63b of the first support material 63 may be subjected to roughening treatment such that voids that are formed at the interface between a display panel and the adhesive layer are forced to rapidly disappear at the time of bonding to the display panel. In this treatment, the lower side 63b is preferably formed in a rough surface structure having a surface roughness of 2.0 to 20 μm in ten-point average roughness Rz prescribed in JIS B0601 (2001). The lower side 63b has a surface roughness of more preferably 2.0 to 10 μm, further preferably from 2.0 to 6 μm, in ten-point average roughness Rz. When the lower side 63b has a rough surface structure having Rz in the above-mentioned ranges, the adhesive layer 14 is easily configured so as to have an upper side 14a adjacent to the protective film 16 formed in a rough surface structure following the rough surface structure of the lower side 63b. On the other hand, the lower side 63b has a surface roughness of preferably from 0.2 to 1.0 μm in arithmetic average roughness Ra.

Another layer, which can form a rough surface structure, may be bonded to the lower side 63b of the first support material 63 to provide the lower side with a rough surface structure. For example, the lower side 63b of the first support material 63 made of a polypropylene can be provided with a rough surface structure by bonding a polymer blend layer made of polypropylene and polyethylene, which are both polyolefin-based polymers.

The lower side 63b may have a rear surface layer disposed thereon so as to facilitate removal from the adhesive layer 14. The rear surface layer is preferably a film having a relatively low adhesion made of e.g. a polyethylene, a polypropylene or a fluorinated resin. In order to further facilitate removal, a release agent, such as silicone, may be applied to the lower side 63b or the rear surface layer within a range having no adverse effect.

The barrier layer 64 (i.e. gas barrier layer) is a layer which prevents gas (such as oxygen gas or nitrogen gas) from passing through the protective film 16 from outside and intruding into the adhesive layer 14, and which is preferably made of a material having a low gas permeability. With regard to the gas permeability, it is possible to speculate the degree by measuring the “oxygen permeability” according to the standard prescribed in JIS K 7126. The protective film 16 with the barrier layer 64 disposed thereon has an “oxygen permeability” of preferably at most 100 cc/m²·day·atm.

There is no particular limitation to the material for the barrier layer 64. For example, an inorganic compound, such as oxide, nitride, a sulfide or carbide, a clay-based material, or a composite of a resin and an inorganic material or clay is preferred. Specifically, silicon oxide (SiO₂), aluminum oxide (Al₂O₃), silicon nitride, silicon oxynitride, aluminium oxynitride, magnesium oxide, zinc oxide, Indium oxide, tin oxide or a crystal clay structure made of layer silicate may be mentioned. Among them, silicon oxide (SiO₂) or aluminum oxide(Al₂O₃) is particularly preferred.

The barrier layer 64 has a thickness of preferably at least 0.01 μm (more preferably from 0.02 to 2 μm) in order to have an improved gas barrier property.

Each of the second support material 65 and the third support material 67 is preferably a film made of a polyester-based resin having an excellent gas barrier property, in particular a film made of polyethylene terephthalate (hereinbelow, referred to as PET). As such a polyester-based resin, polyethylene naphthalate (PEN) may be also employed besides PET.

Further, a polyamide-based resin, such as nylon-6 or nylon-66, may be also employed. Polyvinyl alcohol may be also employed.

Each of the second support material 65 and the third support material 67 has a thickness of preferably from 5 to 50 μm when being a film made of polyester-based resin, such as PET. When the thickness is at least 5 μm, it is possible to have an increased gas barrier property. When the thickness is at most 50 μm, the protective film 16 is likely to flex during peeling, which facilitates peeling operation.

As the bonding layer 66 (which may be an adhesive layer) may be an acrylic-based, a rubber-based, a silicone-based or a urethane-based bonding agent or an adhesive.

The slightly-adhesive layer 68 serves the function of removably affixing the protective film 16 to a supporting surface material (described layer) and may be an adhesive layer made of, e.g. an ethylene vinyl acetate resin, an acrylic resin or a styrene-based resin, among of which an ethylene vinyl acetate resin is preferred because of having a self-adhesive property. When the first support material 63 is made of, e.g. polypropylene as described layer, the slightly-adhesive layer can be advantageously integrally molded along with the first support material 63 by a molding method, such as a coextrusion method using an ethylene vinyl acetate resin. The slightly-adhesive layer 68 has a weaker adhesive force than the adhesive layer 14 since the slightly-adhesive layer is peeled after being affixed to the supporting surface material in the production of the transparent plate according to the present invention. The slightly-adhesive layer 68 has an adhesive force of preferably from 0.02 to 0.2 N, more preferably from 0.04 to 0.01 N, on its adhesive surface by a test specimen with a width of 25 mm in a 180° C. peeling test at a peeling rate of 300 mm/min against an acrylic plate. When the adhesive force is at least 0.02 N, bonding to the supporting surface material is possible, and when it is at most 0.2 N, it is easy to peel the protective film 16 from the supporting surface material.

The supporting surface material is employed to hold the protective film 16 in a step of overlaying the protective film 16 on the adhesive layer 14 and bonding the protective film to the adhesive layer in the process for producing a display device described layer.

The protective film 16 has an “oxygen permeability” of at most 100 cc/m²·day·atm, preferably at most 10 cc/m²·day·atm. By this arrangement, it is possible to prevent atmospheric air from passing through the protective film 16 and intruding into the adhesive layer 14 until the transparent plate having an adhesive layer 1 is employed to be affixed to an object to be bonded after having been produced, i.e. until the transparent plate having an adhesive layer is bonded to the surface of the display panel of a display device in order to produce the display device after having been produced. The oxygen permeability of the protective film 16 was measured under an environment of 25° C. by means of O₂ gas by a gas permeability measuring device named K-315-N manufactured by TRS Tsukuba Rikaseiki K.K. (in compliance with the standard prescribed in JIS K7126).

When the adhesive layer 14 is made of a photo-curable composition and is formed by applying e.g. ultraviolet light or visible light having a short wavelength to the photo-curable resin composition through the protective film 16 for curing as described layer, the protective film 16 is required to have a sufficient permeability to the wavelength of light applied in a state where the protective film is brought into contact with the adhesive layer 14.

In this case, the protective film 16 has a permeability of preferably at least 50% to ultraviolet light (having a wavelength of 360 nm).

In this embodiment, the adhesive layer 14 is made of a photo-curable composition. When the adhesive layer 14 is made of, e.g. a thermosetting composition, the protective film 16 may be made of a protective material having a low optical permeability (one having foil made of metal, such as aluminum) since it is not necessary to apply light through the protective film.

The protective film 16 may be fabricated by the following method for example.

By dry laminating or another technique, the third support material 67 is laminated, through the adhesive layer 66, on the second support material 65 with the barrier layer 64 being disposed thereon. Next, the first support material 63 is laminated on this laminate by e.g. thermal fusion, and the slightly-adhesive layer 68 is disposed on the upper side 67a of the third support material 67 to obtain the protective film 16 shown in FIG. 2.

There is no particular limitation to the method for disposing the barrier layer 64. The barrier layer may be disposed on the second support material 65 (or the first support material 63) by e.g. vapor deposition, sputtering technique, plasma CVD technique, a wet method, such as a sol-gel method.

Further, the third support material 67 may have a transparent conductive layer disposed on a side opposite to the side in contact with the adhesive layer 66. In this case, when the transparent plate having an adhesive layer 1 is bonded to an IPS liquid crystal display panel, electrical grounding the liquid crystal panel is advantageously facilitated. The transparent conductive layer has a surface resistance of preferably 10² to 10⁸ Ω/═.

### SECOND EXAMPLE

FIG. 26 is a schematic cross-sectional view illustrating a protective film 16B as a second example of the protective film 16. In the following explanation, like reference numerals will be used in reference to common parts to the protective film 16 (16A) shown in FIG. 2, and explanation of those parts will be omitted.

The protective film 16B includes a first support material 63, a barrier layer 64 disposed on an upper side 63a of the first support material, a second support material 65 laminated on an upper side 64a of the barrier layer 64, and a slightly-adhesive layer 68 disposed on an upper side 65a of the second support material 65.

The protective film 16B may be fabricated by e.g. the method described below:

The second support material 65 with the barrier layer 64 disposed thereon is laminated on the upper side 63a of the first support material 63 by e.g. thermal fusion, and the slightly-adhesive layer 68 is disposed on the upper side 65a of the second support material 65, obtaining the protective film 16B.

### THIRD EXAMPLE

FIG. 27 is a schematic cross-sectional view illustrating a protective film 16C as a third example of the protective film 16.

The protective film 16C includes a first support material 63, a barrier layer 64 disposed on an upper side 63a of the first support material, and a slightly-adhesive layer 68 disposed on an upper side 64a of the barrier layer 64.

The protective film 16C may be fabricated by e.g. the method described below:

The protective film 16C is obtained by disposing the slightly-adhesive layer 68 on the upper side 64a of the barrier layer 64, which is disposed on the upper side 63a of the first support material 63.

The protective film 16 may be formed in the same outer shape as the adhesive layer 14 in planar view. In the case shown in FIG. 17, the protective film 16 is formed in the same shape as the adhesive layer 14 (e.g. a rectangular shape) in planar view.

The peripheral end face 16b of the protective film 16, the peripheral end face 14b of the adhesive layer 14 and the peripheral end face 13b of the intermediate material 13 coincide one another in plan view, and these members are cut so as to have the edges flush with one another by the cutting blade 7 (see FIG. 4).

Although the peripheral end faces 16b, 14b and 13b are cut in their entire peripheries in the shown case, the peripheral end faces 16b, 14b and 13b may be partly cut, not in their entire peripheries. For example, the peripheral end faces 16b, 14b and 13b having a rectangular shape in plan view may be cut at at least one side, i.e. anywhere from one side to three sides of the four sides.

The shape of the protective plate 10, the covering material 11, the intermediate material 13 and the protective film 16 in planar view is not limited to be rectangular and may be another shape, such as a polygonal or circular shape.

### <Process for Producing Transparent Plate Having Adhesive Layer>

The process for producing a transparent plate having an adhesive layer according to this embodiment is a process including the following steps (a) to (j):

(a) a step of preparing a laminate including a support film for the supporting surface material, an intermediate material film for the intermediate material, a cover film for the cover material, an adhesive layer for the cover material, and a protective film;

(b) a step of cutting the intermediate material film for the intermediate material, the cover film for the cover material, the adhesive layer for the cover material and the protective film forming the laminate to divide each of these members into a central part (i.e. a portion corresponding to an inner region of the protective film) and an outer part (i.e. a portion corresponding to an outer region of the protective film);

(c) a step of laminating the laminate on a transparent plate after removing the outer part of the protective film;

(d) a step of peeling the laminate from the transparent plate, leaving the cover material and the intermediate material;

(e) a step of applying a second composition on a surface of the intermediate material to form a seal portion;

(f) a step of supplying a first composition for forming a layer portion to a region surrounded by the seal portion;

(g) a step of overlaying the supporting surface material with the protective film affixed thereon, onto the seal portion and the first composition so as to bring the protective film into contact with the seal portion and the first composition in a reduced-pressure atmosphere, thus obtaining a laminate with the layer portion made of the first composition and placed in an uncured state being sealed therein;

(h) a step of increasing the pressure to more than 50 kPa from the reduced-pressure atmosphere and keep the increased pressure, followed by curing the layer portion in an uncured state and the seal portion in an uncured or semi-uncured state to form an adhesive layer having the layer portion and the seal portion;

(i) a step of peeling the supporting surface material from the protective film; and

(j) a step of cutting the protective film, the adhesive layer and the intermediate material so as to divide each of these members into a peripheral portion and an inner portion, and removing the peripheral portion.

Now, each of steps (a) to (j) will be specifically described.

### (Step (a))

As shown in FIG. 3, a laminate 5 is prepared so as to include a support film 3, an intermediate material film 13A, a cover material film 11A and a protective film 4.

The cover material film 11A may be a film made of e.g. PET. The cover material film 11A may be formed in a shape corresponding to the outer shape of the protective plate 10. The cover material film 11A has a cover material adhesive layer 17 formed on a lower side thereon, and the protective film 4 is affixed to an adhesive surface of the cover material adhesive layer.

The intermediate material film 13A may be a comparatively flexible film made of an polyolefin-based resin, such as polyethylene or polypropylene, and capable of being easily cut by the cutting blade 7 described layer. The intermediate material film 13A may be formed in a shape corresponding to the outer shape of the protective plate 10. The intermediate material film 13A is affixed to an upper side of the cover material film 11A through an adhesive layer for the intermediate material 19. The adhesive layer for the intermediate material 19 may be a self-adhesive layer monolithically molded along with the intermediate film 13A e.g. a coextrusion method.

The support film 3 may be a film made of e.g. PET. The support film 3 is affixed to an upper side of the intermediate material film 13A through an adhesive layer for the support film 21. The intermediate material film 13A may have a side in contact with the adhesive layer for the support film 21 surface-roughened to improve the adhesiveness with a portion of an adhesive layer 14 in an outer region 14e described layer.

### (Step (b))

As shown in FIG. 4, each of the intermediate material film 13A, the cover material film 11A and the protective film 4 is divided into an outer portion and a central portion by means of a cutting blade 6 formed in e.g. a rectangular frame shape.

Specifically, the intermediate material film 13A is cut and divided into the intermediate material 13 (outer part) and a central part 13d, the cover material film 11a is cut and divided into the cover material 11 (outer part) and a central part 11d, and the protective film 4 is cut and divided into an outer part 4e and a central part 4d. It is preferred that the cutting blade 6 be introduced up to the vicinity of a center part of the support film 3 (in a thickness direction thereof) for sure cut.

### (Step (c))

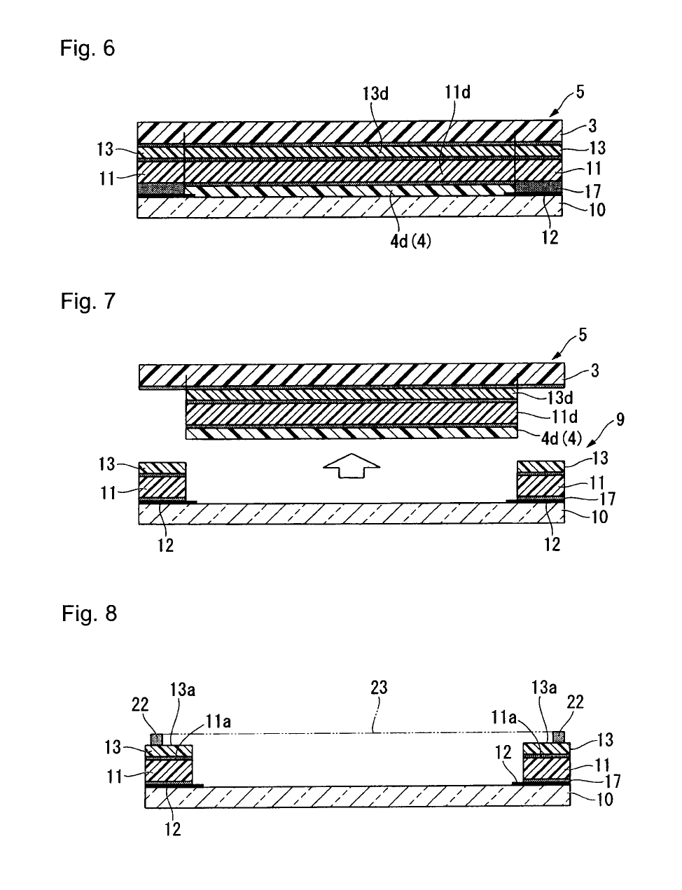

As shown in FIGS. 5 and 6, the outer part 4e of the protective film 4 is removed, and the laminate 5 is brought into contact with the upper side 10a of the protective plate 10.

The adhesive layer for the cover material 17 is exposed at a portion of the protective film 4 with the outer part 4e removed therefrom, the cover material 11 is affixed to the upper side 10a in the peripheral portion of the protective plate 10 by the adhesive layer for the cover material 17, being laminated on the protective plate.

Because the central part 4d of the protective film 4 is affixed to the central part 11d of the cover material film 11A, the central part 11d is prevented from being affixed to the protective plate 10. When the light-shielding printed portion 12 is formed on the peripheral portion of the protective plate 10, the adhesive layer 17 will not adhere on the upper side 10a of the protective plate 10 except for the light-shielding printed portion 12. In other words, the protective film 4d after cutting is larger than an opening of the light-shielding printed portion.

This step (c) is a step of laminating the cover material 11 on the upper side 10a of the protective plate 10.

### (Step (d))

When the laminate 5 is moved from the protective plate 10 in a peeling direction as shown in FIG. 7, the support film 3, the central part 13d of the intermediate material 13 and the central part 11d of the cover material 11 are easily peeled from the protective plate 10, being accompanied by the central part 4d of the protective film 4.

On the other hand, part of the cover material 11 affixed to the protective plate 10 by the adhesive layer 17, and part of the intermediate material 13 affixed to the cover material 11 by the adhesive layer 19 are left on the protective plate 10. The laminate affixed to the protective plate 10 by the adhesive layer 17 and shown in FIG. 7 is called a laminate 9.

### (Step (e))

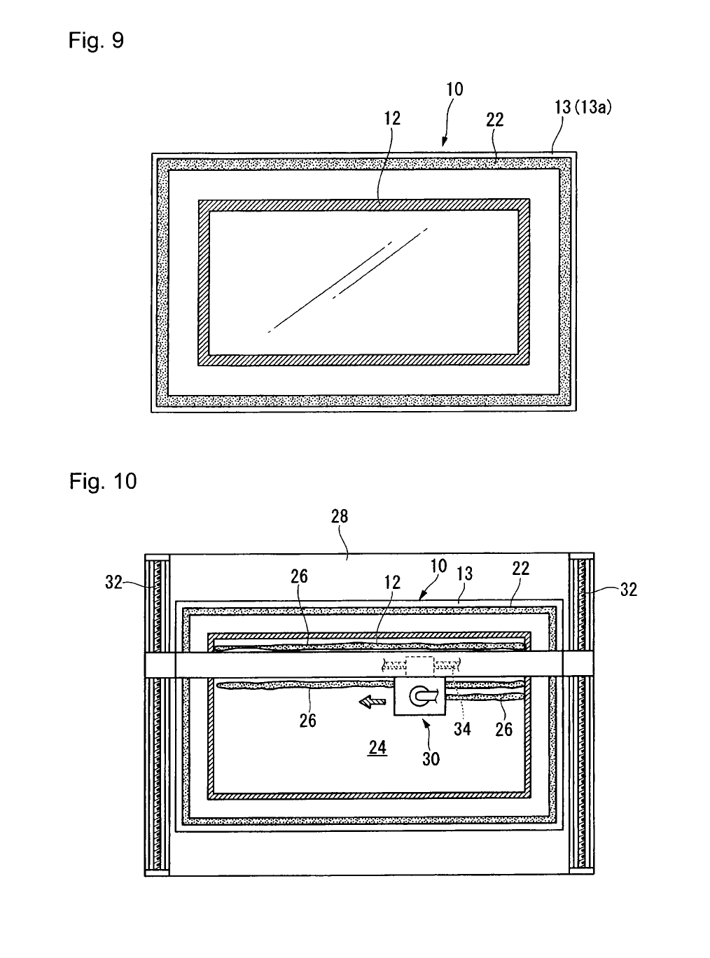

As shown in FIGS. 8 and 9, a seal portion-forming resin composition (second composition) is applied on the upper side 13a of the intermediate material 13 by e.g. a dispenser (not shown) to form the seal portion 22.

Since the intermediate material 13 is located on a side where the upper side 11a of the cover material 11 lies, it can be said that the seal portion 22 disposed on the upper side 13a of the intermediate material 13 is located on a side where the upper side 11a of the cover material 11 lies (the opposite side of a side where the protective plate 10 lies). In this way, the seal portion 22 is disposed “on the cover material 11”.

The application is conducted by means of, e.g. a printer or a dispenser. The seal portion 22 may be placed in an uncured state or in a semicured state where the seal portion is partly cured. Partially curing of the seal portion 22 is conducted by light irradiation when the second composition is a photocurable composition. For example, ultraviolet light or visible light with a short wavelength is applied from a light source (such as, an ultraviolet lamp, a high pressure mercury lamp or UV-LED) to partially cure the photocurable resin composition.

The second composition has a viscosity of preferably from 500 to 3,000 Pa·s, more preferably from 800 to 2,500 Pa·s, further preferably from 1,000 to 2,000 Pa·s. When the viscosity is at least 500 Pa·s, the shape of the seal portion can be maintained for a relatively long period of time, and the height of the seal portion can be sufficiently maintained. When the viscosity is at most 3,000 Pa·s, the cured seal portion can be formed by coating.

Even in a case where the viscosity of the second composition forming the seal portion is smaller than 500 Pa·s at the time of application, when the second composition is a photocurable composition, the viscosity of the second composition after light irradiation may be set within one of the above-mentioned ranges by carrying out light irradiation just after application. From the viewpoint of ease in application, the viscosity of the second composition is preferably at most 500 Pa·s, more preferably at most 200 Pa·s at the time of application.

In Description, the viscosity of the second composition and the first composition described later are measured at 25° C. by means of an E-model viscometer.

The second composition may be a photocurable resin composition or a thermosetting resin composition. As the second composition, a photocurable resin composition containing a curable compound and a photopolymerization initiator (C) is preferred from the viewpoints that the curing can be carried out at a low temperature, and the curing speed is high, and that the second composition having a low viscosity can be made highly viscous by light irradiation just after application.

The second composition is preferably one which contains, as the curable compound, at least one oligomer (A) having a curable group and having a number average molecular weight of 30,000 to 100,000 and at least one monomer (B) having a curable group and having a molecular weight of from 125 to 600, wherein the content of the monomer (B) is from 15 to 50 mass % of the total amount (100 mass %) of the oligomer (A) and the monomer (B), from the viewpoint that the viscosity can be easily controlled so as to be set within one of the above-mentioned ranges. When the viscosity is controlled so as to be set within one of the above-mentioned ranges by light irradiation just after application, the content of the monomer (B) in the curable compound is preferably from 15 to 50 mass % of the total amount (100 mass %) of the oligomer (A) and the monomer (B).

The curable group in the oligomer (A) may, for example, be an addition-polymerizable unsaturated group (such as an acryloyloxy group or a methacryloyloxy group), or a combination of an unsaturated group and a thiol group. It is preferably a group selected from an acryloyloxy group and a methacryloyloxy group in that the curing speed is high.

The oligomer (A) is preferably one having an average of from 1.8 to 4 curable groups per one molecule from the viewpoint of the curing property of the second composition and the mechanical properties of the seal portion. The oligomer (A) may, for example, be a urethane oligomer having a urethane bond, a poly(meth)acrylate of a polyoxyalkylene polyol, or a poly(meth)acrylate of a polyester polyol. From the viewpoint that the mechanical properties of the resin after curing, the adhesion with a transparent plate or a display panel, etc. can be widely adjusted by the molecular weight design of the urethane chain, etc., a urethane oligomer (A1) is preferred. One kind of oligomer (A) or two kinds of oligomers (A) may be employed.

The curable group in the monomer (B) may, for example, be an addition-polymerizable unsaturated group (such as an acryloyloxy group or a methacryloyloxy group), or a combination of an unsaturated group and a thiol group. It is preferably a group selected from an acryloyloxy group and a methacryloyloxy group in that the curing speed is high and that a seal portion having a high transparency can be obtained.

The monomer (B) preferably contains a monomer (B3) having a hydroxy group from the viewpoint of the adhesion between the seal portion and a display panel or the solubility of various additives described later. As the monomer (B3) having a hydroxy group, a hydroxy acrylate having from 1 to 2 hydroxy groups and having C₃₋₈ or a hydroxy methacrylate having hydroxy acylate groups (such as 2-hydroxypropyl acrylate, 2-hydroxybutyl acrylate, 4-hydroxybutyl acrylate, 6-hydroxyhexyl acrylate, 2-hydroxypropyl methacrylate, 2-hydroxybutyl methacrylate, 4-hydroxybutyl methacrylate or 6-hydroxyhexyl methacrylate) is preferred, and 4-hydroxybutyl acrylate and 2-hydroxybutyl methacrylate is particularly preferred. One kind of monomer (B) or two kinds of monomers (B) may be also employed.

As the photopolymerization initiator (C), a photopolymerization initiator of e.g. acetophenone type, ketal type, benzoin or benzoin ether type, phosphine oxide type, benzophenone type, thioxanthone type, a quinone type or the like may be mentioned. By using two or more photopolymerization initiators (C) having different absorption wavelength regions in combination, it is possible to further accelerate the curing time or to increase the surface hardness at the seal portion. When the viscosity of the second composition is controlled so as to be set within one of the above-mentioned preferred ranges by light irradiation just after application, it is particularly preferred to employ two or more photopolymerization initiators (C) having different absorption wavelength regions in combination.

When a peripheral portion to be cut and removed 13e has a narrow width, the seal portion 22 is preferred to have a width set so as to be narrow, although depending on a position cut by the cutting blade 7 described later, the size of the light-shielding printed portion, or the position of the seal portion on the upper side 13a of the intermediate material 13. The width of the seal portion is preferably from 0.5 to 2 mm, more preferably from 0.8 to 1.6 mm.

The seal portion 22 has preferably a larger shearing modulus than a layer portion 23 at 25° C. When the shearing modulus of the seal potion 22 is larger than that of the layer potion 23, even if a void remains at the interface between a display panel and the adhesive layer 14 at the peripheral portion of the adhesive layer 14 at the time of bonding the display panel and the transparent plate having an adhesive layer, the void is difficult to be open to exterior and easily becomes an independent void. Accordingly, when the display panel and the transparent plate having an adhesive layer 1 are bonded in a reduced pressure atmosphere and then returned to an atmospheric pressure atmosphere, the volume of voids is reduced due to the differential pressure between the pressure in the voids (pressure kept in a reduced state) and the pressure exerted to the adhesive layer (i.e. atmospheric pressure), whereby the voids are apt to be disappear.

By setting the shearing modulus of the seal portion 22 so as to be larger than the shearing modulus of the layer portion 23, it becomes easy to produce the transparent plate having an adhesive layer 1 such that the seal portion 22 has a slightly thicker than the layer portion 23 in at least one part of the seal portion 22 in its area adjoining the layer portion 23.

Although the seal portion 22 is formed on the intermediate material 13 in this embodiment, the transparent plate having an adhesive layer according to the present invention may be produced with no intermediate material. In this case, the seal portion 22 may be formed on the upper side 11 a of the cover material 11.

### (Step (f))

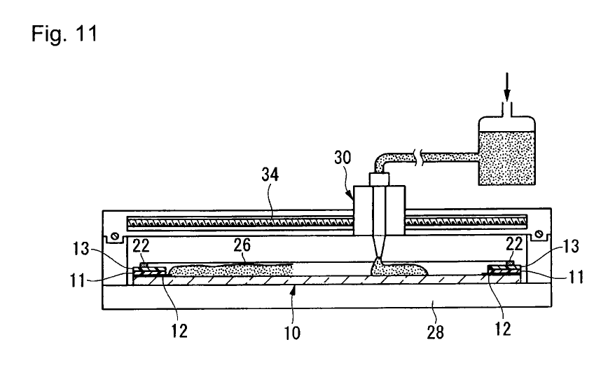

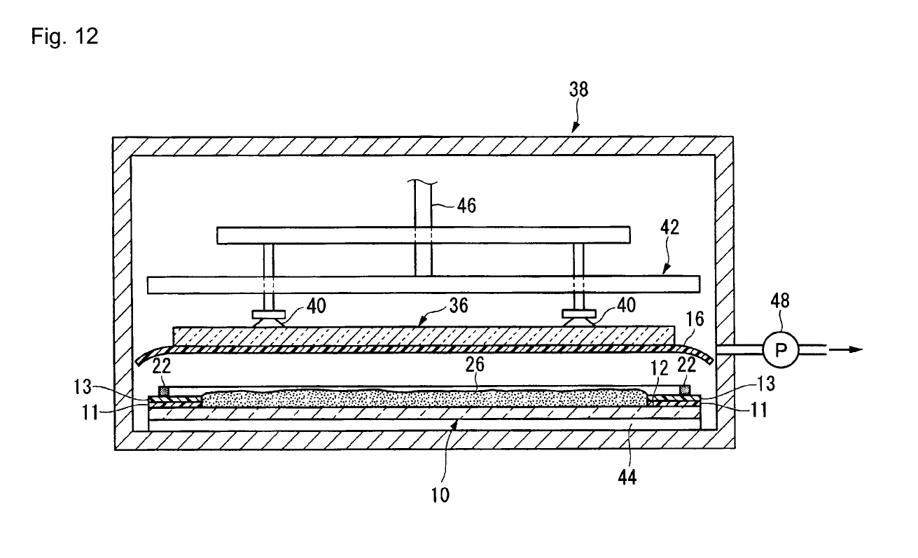

After Step (e), a layer portion-forming photocurable resin composition 26 (first composition) is supplied to a rectangular region 24 of the protective plate 10 surrounded by the seal portion 22 as shown in FIGS. 10 and 11. The amount of the resin composition 26 (first composition) is preliminarily set to be an amount such that the space to be sealed by the seal portion 22, the intermediate material 13, the cover material 11, the protective plate 10 and the protective film 16 (see FIG. 12) is filled by the resin composition 26.

As the supplying method, a method may be mentioned wherein the protective plate 10 is horizontally placed, and the composition is supplied in a dot, line or strip pattern by a supplying means such as a dispenser or a die coater.

Supplying of the resin composition 26 is, for example, carried out in such a manner that as shown in FIGS. 10 and 11, the protective plate 10 is horizontally placed on a lower platen 28, and the resin composition 26 (first composition) is supplied in a line, strip or dot-form by means of a horizontally moving dispenser 30.

The dispenser 30 is made to be horizontally movable in the entire range of the region 24 by a known horizontal movement mechanism including a pair of feed screws 32 and a feed screw 34 perpendicular to the feed screws 32. Instead of the dispenser 30, a die coater may be employed.

The first composition has a viscosity of preferably from 0.05 to 50 Pa·s, more preferably from 1 to 20 Pa·s. When the viscosity is at least 0.05 Pa·s, it is possible to reduce the proportion of a monomer (B′) described later, and thereby to prevent the layer portion 23 from being more fragile. Further, as a low boiling point component decreases, such being advantageous for a suppression in evaporation in a reduced pressure atmosphere described later. When the viscosity is at most 50 Pa·s, voids tend to less likely to remain in the layer portion 23.

The first composition may be a photocurable resin composition or a thermosetting resin composition. As the first composition, a photocurable resin composition containing a curable compound and a photopolymerization initiator (C′) is preferred from the viewpoint that curing can be made at a low temperature, and the curing speed is high.

The layer portion-forming photocurable resin composition is preferably one which contains, as the curable compound, at least one oligomer (A′) having a curable group and having a number average molecular weight of from 1,000 to 100,000, and at least one monomer (B′) having a curable group and having a molecular weight of from 125 to 600, wherein the content of the monomer (B′) is from 40 to 80 mass % of the total amount (100 mass %) of the oligomer (A′) and the monomer (B′), from the viewpoint that the viscosity can be easily controlled so as to be set within one of the above-mentioned ranges.

The curable group in the oligomer (A′) may, for example, be an addition-polymerizable unsaturated group (such as an acryloyloxy group or a methacryloyloxy group), or a combination of an unsaturated group and a thiol group, and a group selected from an acryloyloxy group and a methacryloyloxy group is preferred from the viewpoint that the curing speed is high, and the layer portion 23 is formed so as to have a high transparency.

The curable group in the monomer (B′) may, for example, be an addition-polymerizable unsaturated group (such as an acryloyloxy group or a methacryloyloxy group), or a combination of an unsaturated group and a thiol group, and a group selected from an acryloyloxy group and a methacryloyloxy group is preferred from the viewpoint that the curing speed is high, and the layer portion 23 is formed so as to have a high transparency.

The monomer (B′) is preferably one having from 1 to 3 curable groups per one molecule from the viewpoint of the curing property of the layer portion-forming photocurable resin composition and the mechanical properties of the seal portion 23.

As the photopolymerization initiator (C′), a photopolymerizable initiator of e.g. acetone type, ketal type, benzoin or benzoin ether type, phosphine oxide type, benzophenone type, thioxanthone type or quinone type may be mentioned.

By supplying the first composition in a liquid state in the region surrounded by the seal portion 22, the layer portion 23 is formed so as to spread along the surface of the protective plate 10 and have the peripheral portion brought into contact with the seal portion 22.

Because the adhesive layer 14 is brought into contact with the seal portion 22 to outwardly expand the peripheral portion of the layer portion 23, it is possible to prevent the peripheral portion from being thinned with the result that the entire thickness of the layer portion 23 can be kept uniformly. By making the entire thickness of the layer portion uniform, it is easy to suppress the stay of voids at the interface between the layer portion and another surface material (an object to be bonded) at a time of bonding both members.

### (Step (g))

Then, as shown in FIG. 12, the protective plate 10 and the supporting surface material 36 having the protective film 16 bonded thereto are brought into a decompression device 38. At an upper portion in the decompression device 38, an upper platen 42 having a plurality of suction pads 40 is disposed, and at a lower portion in the decompression device, a lower platen 44 is provided. The upper platen 42 is made to be vertically movable by an air cylinder 46.

The supporting surface material 36 is attached to the suction pads 40 such that the surface of the supporting surface material with the protective film 16 bonded thereto faces downward. The protective plate 10 is fixed on the lower platen 44 such that the surface of the protective plate with the resin composition 26 supplied thereto faces upward.

Then, the air in the decompression device 38 is suctioned by a vacuum pump 48. After the atmospheric pressure in the decompression device 38 has reached, for example, a reduced pressure atmosphere of from 15 to 100 Pa, the air cylinder 46 is operated to let the supporting surface material 36 descend towards the protective plate 10 being standby below, in such a state that the supporting surface material 36 is suction-held by the suction pads 40 of the upper platen 42.

The protective plate 10 and the supporting surface material 36 with the protective film 16 bonded thereto are laminated via the seal portion 22. This arrangement constitutes a laminate wherein the uncured layer portion 23 made of the resin composition 26 is sealed by the protective plate 10, the protective film 16, the intermediate material 12, the cover material 11 and the seal portion 22, and the laminate is maintained in a reduced pressure atmosphere for a certain period of time.

### (Step (h))

Then, the decompression device 38 is made to have e.g. an atmospheric pressure atmosphere (such as at least atmospheric pressure of 50 kPa) therein, and then, the laminate is taken out from the decompression device 38. When the laminate is placed in an atmospheric pressure atmosphere, the surface of the uncured layer portion 23 facing the protective plate 10 and the surface of the uncured layer portion 23 facing the supporting surface material 36 of the laminate are pressed by the atmospheric pressure, whereby the uncured layer portion in the sealed space is pressed by the protective plate 10 and the supporting surface material 36. By such a pressure, the uncured layer portion in the sealed space will flow, and the entire sealed space will be uniformly filled with the uncured layer portion 23.

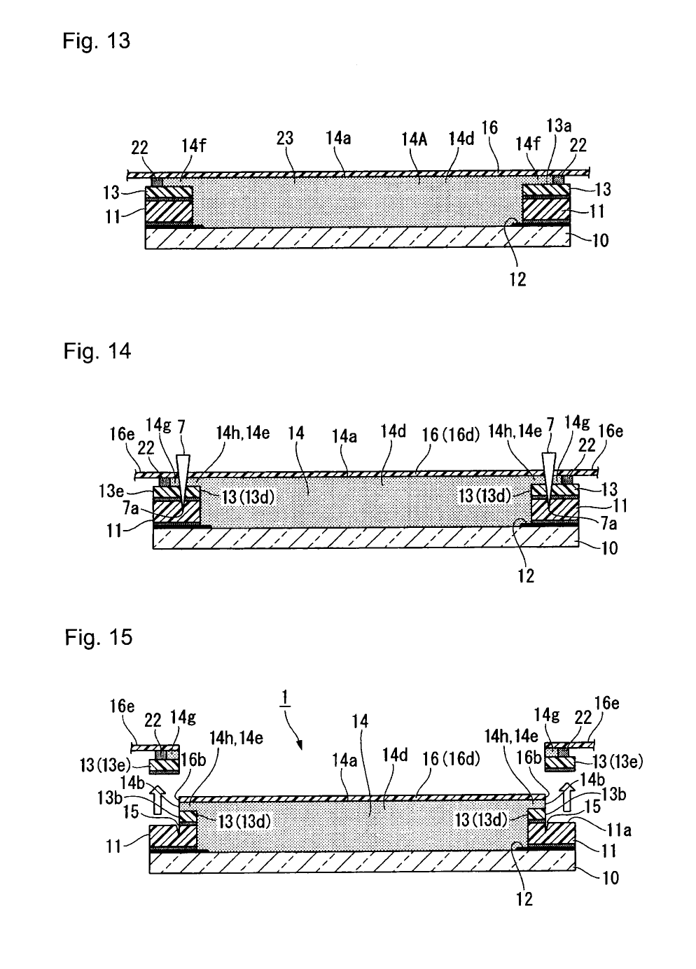

Then, from outside the supporting surface material 36 of the laminate, light (ultraviolet light or visible light with a short wavelength) is applied to the uncured or semi-cured seal portion 22 and the uncured layer portion 23 to cure the uncured or semi-cured seal portion 22 and the uncured layer portion 23 in the laminate thereby to form an adhesive layer 14A (see FIG. 13).

The adhesive layer 14A is provided with a sufficient thickness since the layer portion 23 is formed in a region having a sufficient height surrounded by the cover material 11, the intermediate material 13 and the seal portion 22.

Subsequently, the supporting surface material 36 (see FIG. 12) is peeled from the protective film 16 to obtain a laminate shown in FIG. 13.

The adhesive layer 14A includes the inner region 14d and an extension 14f formed so as to outwardly extend from the peripheral portion of the inner region 14d on and along the upper side 13a of the intermediate material 13.

### (Step (i))

As shown in FIG. 14, the cutting blade 7, which is formed in e.g. a rectangular frame form, is employed to cut the protective film 16, the adhesive layer 14 and the intermediate material 13 into peripheral portions and inner portions, respectively.

Specifically, the cutting blade 7 is moved downward (in other words, in a direction vertical to the protective plate 10), having a leading edge 7a directed downward, and the protective film 16 is separated into a peripheral portion 16e and an inner portion 16d by the cutting blade 7.

When the cutting blade 7 is further moved downwardly, the cutting blade 7 cuts into the extension 14f of the adhesive layer 14 from its upper side 14a in a thickness direction of the extension to separate the extension 14a of the adhesive layer 14 into a peripheral portion 14g and an inner portion 14h.

When the cutting blade 7 is further moved downward, the cutting blade 7 cuts into the intermediate material 13 from its upper side 13a to separate the intermediate material 13 into a peripheral portion 13e and an inner portion 13d.

The peripheral edge 16b of the protective film 16 (the peripheral edge of the inner portion 16d), the peripheral edge 14b of the adhesive layer 14 (the peripheral edge of the inner portion 14h), and the peripheral edge 13b of the intermediate material 13 (the peripheral edge of the inner portion 13d) coincide one another in plan view, and these members are cut so as to have the edges flush with each other since these portions are cut by a single cutting operation by means of the common cutting blade 7.

When the leading edge 7a of the cutting blade 7 is further advanced so as to cut into the upper side 11 a of the cover material 11 after having cut the intermediate material 13, the notched portion 15 is formed in the upper side 11 a such that the peripheral edges 16b, 14b and 13b coincide with one another in plan view.

Subsequently, as shown in FIG. 15, the peripheral portion 16e of the protective film 16, the peripheral portion 13e of the intermediate material 13 and the peripheral portion 14g of the adhesive layer 14 are removed.

The operation for removing the peripheral portions 16e, 13e and 14g is easier than a case where the adhesive layer 14 is affixed directly on the cover material 11 since the peripheral portion 14g of the adhesive layer 14 etc. are peeled from the cover material 11 along with the peripheral portion 13e of the intermediate material 13.

Thus, the transparent plate having an adhesive layer 1 shown in FIG. 1 is obtained.

Although the removed peripheral portion 14g contains the entire seal portion 22 in the shown embodiment, it is sufficient that the peripheral portion 14g contains at least part of the seal portion 22. From the viewpoint of the uniformity in an end portion of the adhesive layer 14 left after cutting, the removed peripheral portion 14g preferably contains the entire seal portion 22.

As shown in FIG. 17, the protective film 16 is preferred to have slits 16f1 and 16f2 which are at least partly located at positions apart from the peripheral edge 16b. By this arrangement, it is possible to start peeling the protective film 16 at inner edges 16g of the slits 16f1 and 16f2 at positions apart from the peripheral edge 16b.

The slits 16f1 and 16f2 are two linear slits crossing each other and are formed so as to extend along diagonal lines of the protective film 16 and to have opposite ends reaching the peripheral edge 16b. As long as at least part of the protective film 16 is peelable so as to start peeling at a portion apart from the peripheral edge 16b, the position and the number of the slits are arbitrarily set, and the slits may be curved. The slits 16f1 and 16f2 may be formed by bringing a cutting blade (not shown) into contact with an external side of the protective film 16.

### <Display Device>

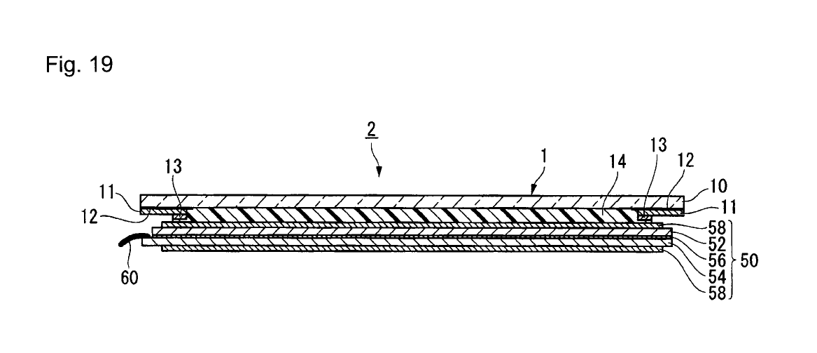

FIG. 19 is a cross-sectional view illustrating an example of the display device using the transparent plate having an adhesive layer 1 according to the embodiment of the present invention.

The display device 2 includes a display panel 50 and the transparent plate having an adhesive layer 1 bonded to the display panel 50 such that the adhesive layer 14 is brought in contact with the display panel 50.

The display device 2 includes the protective plate 10, the display panel 50, the adhesive layer 14 sandwiched between the protective plate 10 and the display panel 50, and a flexible printed circuit board 60 (FPC) connected to the display panel 50 and having a driving IC mounted thereon so as to drive the display panel 50.

### (Display Panel)

As shown in FIG. 19, the display panel 50 according to this embodiment is an example of a liquid crystal panel having a construction wherein a transparent substrate 52 provided with a color filter and a transparent substrate 54 provided with TFTs are bonded via a liquid crystal layer 56, and this assembly is sandwiched between a pair of polarizing plates 58 (a frame 152 being not shown in FIG. 19).

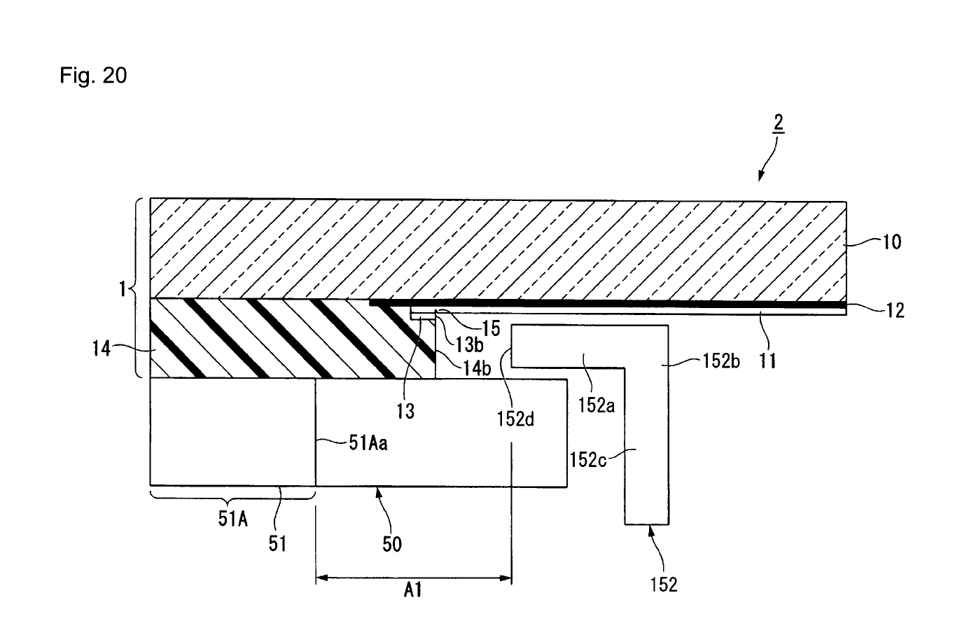

As shown in FIG. 20, the display panel 50 is configured to include a main body 51 constituted by the transparent substrates 52 and 54, the liquid crystal layer 56, the polarizing plates 58 and others, a frame 152 (front frame) disposed on a peripheral edge of the main body 51. The frame 152 may be disposed throughout the entire periphery of the main body 51. Reference numeral 51A designates a portion of the main body 51 which serves as an effective pixel region (image display region).

The frame 152 is formed in an L-character shape in section so as to include a plate-like base portion 152a extending along the protective plate 10 and an extending portion 152c extending from an outer peripheral portion 152b of the base portion 152a in a direction apart from the transparent plate having an adhesive layer 1. The frame has an inner peripheral edge 152d so as to form an opening of the frame 152. The frame 152 may be made of metal, such as aluminum.

The base portion 152a has the inner peripheral edge 152d and its close portion located between the main body 51 of the display panel 50 and the protective plate 10. For this reason, a sufficient space is required between the main body 51 and the protective plate 10.

The opening of the frame 152 has a size close to the size of the effective pixel region 51A, and the region Al between the inner peripheral edge 152d of the frame 52 and an outer periphery 51Aa of the effective pixel region 51A has a width (i.e. the distance along the display panel 50 or a distance in a right and left direction in FIG. 20) of normally only about 1 to 2 mm.

In accordance with the present invention, it is possible to reduce the restriction in the layout of the peripheral edges 14b of the adhesive layer 14 because the width of the peripheral structure (the intermediate material 13 etc.) of the transparent plate having an adhesive layer can be made narrow. Accordingly, the location of the peripheral edge 14b of the adhesive layer 14 in plan view can be easily set between the inner peripheral edge 152d and the outer peripheral edge 51Aa.

Because the peripheral edge 14b of the adhesive layer 14 and its close portion can be set outside the effective pixel region 51A, it is possible to establish a good display quality in the pixels in an outermost peripheral portion of the effective pixel region 51A.

The display panel is not limited to the liquid crystal panel shown in FIG. 19.

The display panel may be one wherein a display material, which has an optical property changeable by an external electrical signal, is sandwiched between a pair of electrodes, of which at least one is a transparent electrode, or between a transparent substrate and a plurality of electrode pairs formed in a single surface. Depending upon the type of the display material, it may, for example, be a liquid crystal panel, an EL panel, a plasma panel, an electron ink type panel or the like.

Further, the display panel has a structure wherein a pair of surface materials, of which at least one is a transparent substrate, are bonded to each other, and is disposed such that the transparent substrate is brought in contact with the layer portion. In such cases, in some display panels, an optical film, such as a polarizing plate or retardation film, may be provided on the outermost layer of the transparent substrate in contact with the layer portion. In such a case, the layer portion serves to bond the protective plate and the optical film on the display panel.

The display panel 50 may be formed in a rectangular shape in plan view. The sizes of the protective plate 10 and the display panel 10 in plan view may be almost equal to each other, and the protective plate 10 may have a larger size than that of display panel 50, taking into consideration the relationship with a casing for housing the display device. Although the protective plate 10 may be formed so as to be conversely slightly smaller than the display panel 50, depending on the structure of the casing, the protective plate is normally formed so as to be larger than the effective pixel region of the display panel.

### [Process for Producing Display Device]

In order to produce a display device, after peeling the protective film from the transparent plate having an adhesive layer according to this embodiment, the display panel and the transparent plate having an adhesive layer with the protective film peeled therefrom are bonded such that the adhesive layer is brought in contact with the display panel.

The process for producing a display device may be a process including Steps S1 and S2 shown below:

### (Step S1: Step for Peeling Protective Film)

In this step, the protective film is peeled from the transparent plate having an adhesive layer which of adhesive layer is covered with the protective film. Hereinbelow, the transparent plate having an adhesive layer with the protective film removed therefrom will be called the transparent plate having an adhesive layer subjected to peeling.

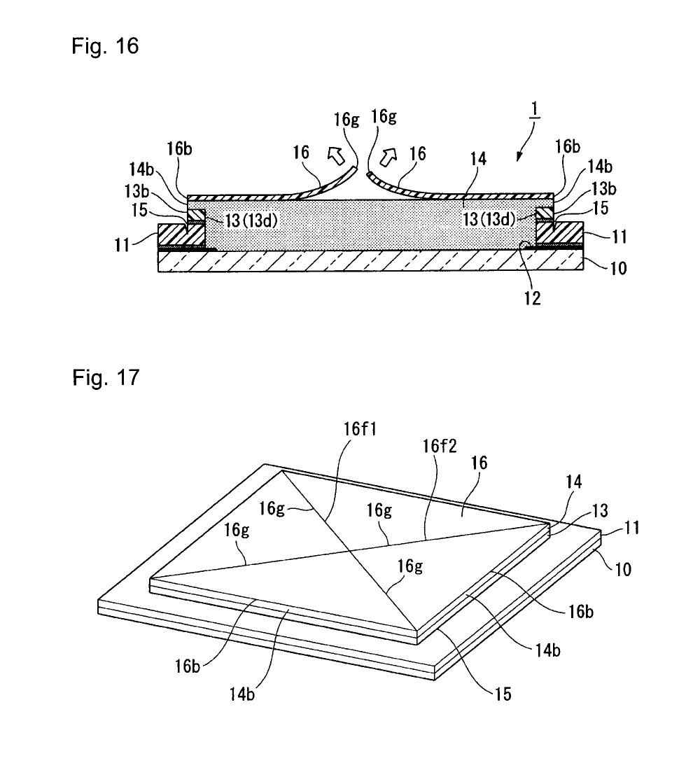

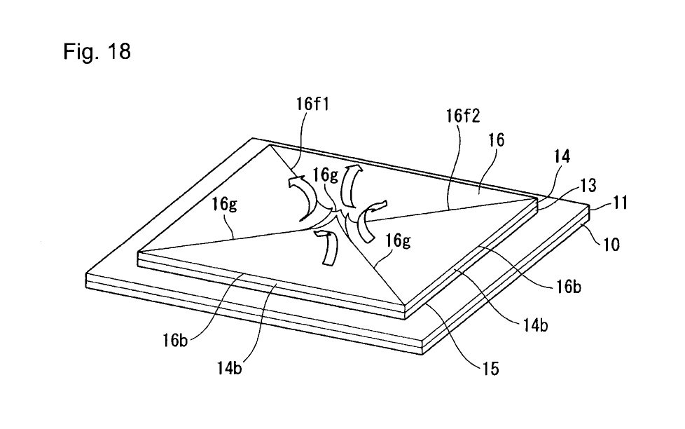

When the protective film 16 exemplified in FIG. 17 is employed, the protective film 16 can be peeled from the adhesive layer 14 by starting the peeling operation at points of the inner edges 16g of the slits 16f1 and 16f2 remote from the peripheral edge 16b (outer peripheral edge) (at a substantially center in the shown embodiment) as shown in FIGS. 16 and 18.

It is possible to prevent the adhesive layer 14 from being inadvertently peeled at the peripheral edge 14b at the time of peeling the protective film 16 since the inner edges 16g (i.e. the substantially center of the protective film 16) are located at positions away from the peripheral edge 14b of the adhesive layer 14.

This step S1 is a step of peeling the protective film 16 from the transparent plate having an adhesive layer 1.

### (Step S2: Bonding Step)

In this step, the display panel and the transparent plate having an adhesive layer subjected to peeling are bonded together, being overlaid so as to bring the adhesive layer in contact with the display panel, in a bonding device. At that time, the display panel and the transparent plate having an adhesive layer subjected to peeling are preferred to be bonded together in a reduced pressure atmosphere in a reduced pressure vessel of the bonding device. By conducting the bonding operation in a reduced pressure atmosphere, voids are less likely to be formed at the interface between the display panel and the adhesive layer. In the reduced pressure vessel, the reduced pressure atmosphere is maintained a certain period of time, followed by releasing the reduced pressure atmosphere to normal pressure. The reduced pressure atmosphere during bonding is set at at most 1 kPa. The reduced pressure atmosphere is preferably from 10 to 500 Pa, more preferably from 15 to 200 Pa.

For example, as shown in FIGS. 19 and 20, the display panel 50 and the transparent plate having an adhesive layer 1 with the protective film 16 peeled therefrom are bonded so as to bring the adhesive layer 14 in contact with the display panel 50.

This step S2 is a step of bonding the display panel and the transparent plate having an adhesive layer subjected to peeling.

The above-mentioned step S1 and step S2 do not need to be subsequently conducted, may be conducted on different days or at different times, or may be conducted at difference places.

In the transparent plate having an adhesive layer 1 according to this embodiment, the protective film 16 and the adhesive layer 14 are cut at the peripheral edges 16b and 14b, respectively, and the cover material 11 is disposed between the protective plate 10 and the adhesive layer 14 at the peripheral edges 16b and 14b and their vicinities.

This arrangement can narrow the width of the peripheral structure (the intermediate material 13 etc.) by cutting out the peripheral portion 14g including at least part of the seal portion 22 (see FIG. 15). In other words, it is possible to cope with widening the effective pixel region 51A (see FIG. 20) by adjusting the bonding position of the cover material or the intermediate material to the transparent plate and the cutting position by the cutting blade 7. That is to say, it is possible to establish the bonding to the transparent plate by the inner region 14d as a uniform adhesive layer.

Further, the adhesive layer 14 is provided with a sufficient thickness since the adhesive layer 14 is formed by filling the resin composition 26 in the region surrounded by the seal portion and having a sufficient height. Thus, it is possible to ensure a sufficient space for disposing the frame 152 between the display panel 50 and the protective plate 10 such that the application to the display panel 50 including the frame 152 is facilitated.

Furthermore, it is possible to protect the protective plate 10 and the light-shielding printed portion 12 by the cover material 11 so as to prevent the damage by the cutting blade 7.

In accordance with the process for producing the transparent plate having an adhesive layer 1 according to this embodiment, it is possible to narrow the width of the peripheral structure (the intermediate material 13 etc.) by cutting out the peripheral portion 14g of the adhesive layer 14. Thus, it is possible to cope with widening the effective pixel region 51A.

Further, the adhesive layer 14 is provided with a sufficient thickness since the adhesive layer 14 is formed by filling the resin composition 26 in the region surrounded by the seal portion 22 and having a sufficient height. Thus, the application to the display panel 50 including the frame 152 is facilitated. Furthermore, it is possible to protect the protective plate 10 and the light-shielding printed portion 12 by the cover material 11.

Since the display device according to this embodiment employs the above-mentioned transparent plate having an adhesive layer 1, it is possible to narrow the width of the peripheral structure by cutting out the peripheral portion 14g of the adhesive layer 14. Thus, it is possible to cope with widening the effective pixel region 51A.

Further, the adhesive layer 14 is provided with a sufficient thickness since the adhesive layer 14 is formed by filling the resin composition 26 in the region surrounded by the seal portion 22 and having a sufficient height. Thus, the application to the display panel 50 including the frame 152 is facilitated. Furthermore, it is possible to protect the protective plate 10 and the light-shielding printed portion 12 by the cover material 11.

In accordance with the process for producing the display device according to this embodiment, it is possible to provide the adhesive layer 14 with a sufficient thickness and a peripheral structure having a narrow width by filling the resin composition 26 inside the seal portion 22 to form the adhesive layer 14, followed by cutting out the peripheral portion 14g including at least part of the seal portion 22, for fabricating the transparent plate having an adhesive layer 1.

Accordingly, it is possible to cope with widening the effective pixel region 51A and with the application to the display panel 10 including the frame 152. Further, it is possible to protect the protective plate 10 and the light-shielding printed portion 12 by the cover material 11.

The process for producing a transparent plate having an adhesive layer according to the present invention may include the following steps (a1) to (d1), instead of the above-mentioned steps (a) to (d):

(a1) a step of preparing a laminate including a support material, an intermediate material, a cover film and a protective film;

(b1) a step of peeling the protective film from the laminate;

(c1) a step of bonding the cover material to a transparent plate; and

(d1) a step of removing the support material from the intermediate material.

Now, this alternative example of the process for producing the transparent plate having an adhesive layer 1 will be specifically described in reference to the accompanying drawings. In the following explanation, the same reference numerals are given to already explained members, and explanation of these members will be omitted or simplified.

(Step (a1))

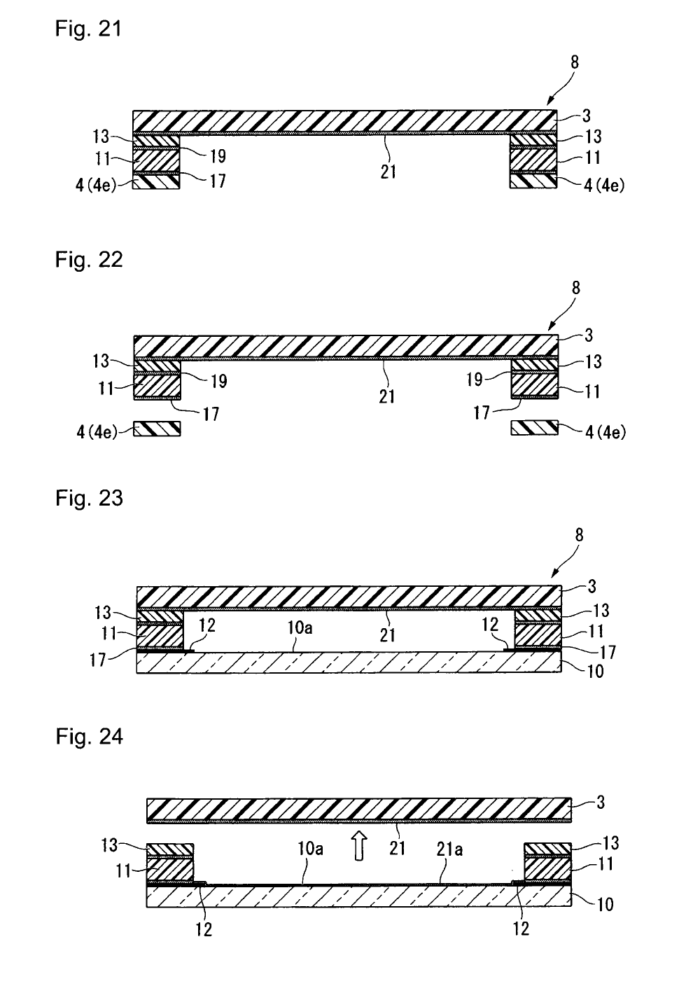

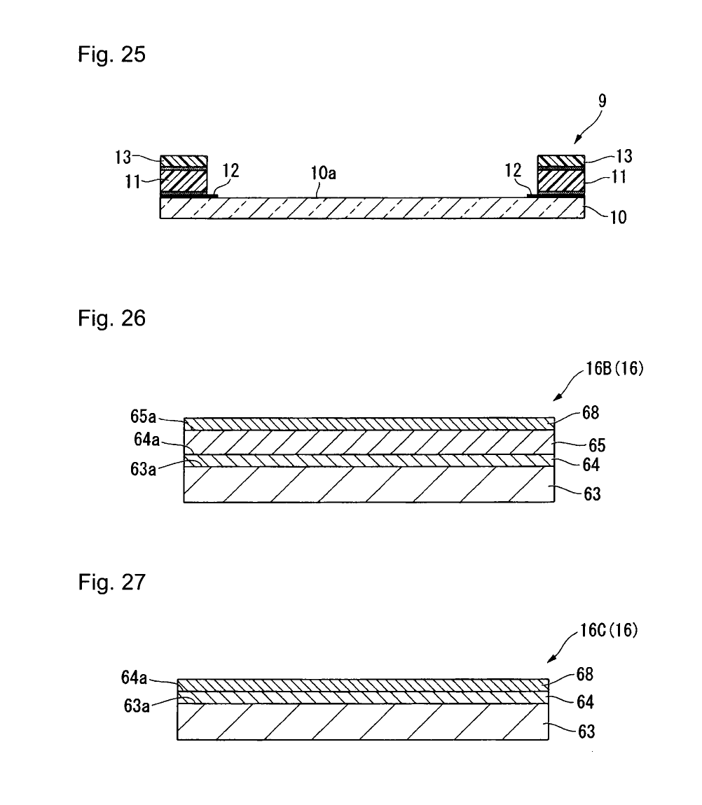

As shown in FIG. 21, a laminate 8 is prepared, including a support film (support material) 3, an intermediate material 13, a cover material 11 and a protective film 4.

The cover material 11 is formed in i.e. a frame shape and has the intermediate material 13 in a frame shape affixed to an upper side thereof by an adhesive layer 19. The support film 3 is affixed to an upper side of the intermediate material 13 by an adhesive layer 21. The cover material 11 has the protective film 4 (outer portion 4e) affixed to a lower side thereof by an adhesive layer 17.

The laminate 8 may be fabricated by cutting the films 13A, 11A and 4 of the laminate 5 shown in FIG. 3 by the cutting blade 6 shown in FIG. 4 (see steps (a) and (b)), followed by removing the central portions 13d, 11d and 4d.

(Step (b1))

When the outer portion 4e of the protective film 4 is peeled from the cover material 11 as shown in FIG. 22, the adhesive layer for the cover material 17 is exposed.

(Step (c1))

When the laminate 8 is brought into contact with an upper side 10a of the protective plate 10 as shown in FIG. 23, the cover material 11 is laminated on the upper side of a peripheral portion of the protective plate 10 through the adhesive layer for the cover material 17 and affixed to the upper side.

Step (c1) is a step of laminating the cover material 11 on the upper side 10a of the protective plate 10.

(Step (d1))

As shown in FIG. 24, the support film 3 is peeled from the intermediate material 13. If a portion 21a of the adhesive forming the adhesive layer 21 on the support film 3 (i.e. a lower side of the support film 3 in FIG. 24) adheres to the upper side 10a of the protective plate 10, the adhering substance can be removed by dry etching etc.

Thus, a laminate 9 can be obtained, having the same structure as that shown in FIG. 7. After that, the above-mentioned steps following step (e) (see FIGS. 8 to 20) can be adopted to fabricate the transparent plate having an adhesive layer 1 shown in FIG. 1.

The technical scope of the present invention is not limited to the above-mentioned embodiment, and numerous variations and modifications can be made without departing from the spirit of the present invention.

Although the above-mentioned embodiment has been described about the process for bonding the transparent plate having an adhesive layer to a display panel to produce a display device, the transparent plate having an adhesive layer may be bonded to a coordinate input device, such as a touch panel.

The transparent plate may be a transparent electrode-equipped transparent plate configuring a touch panel part in a display device with a touch panel. The transparent plate with a touch panel may have an adhesive layer formed on each side, and a protective plate and a display panel with a frame may be bonded together through such a touch panel substrate having an adhesive layer disposed on each side.

Although the notched portion is preferred to be formed in the upper side of the cover material by the cutting blade in order to reliably cut the cover material film and so on in the present invention, a case where almost no notched portion is formed in the upper side of the cover material may be also included in the scope of the present invention.

### INDUSTRIAL APPLICABILITY

In accordance with the present invention, it is possible not only to form a thick adhesive layer but also to obtain a good display quality in the pixels in an outermost peripheral portion of the effective pixel region of a liquid crystal panel, such as a liquid crystal panel, even in a case where the size of the effective pixel region and the size of the opening of the front frame are approximate. The present invention is applicable to various kinds of display devices having a display panel, a coordinate input device and so on.

This application is a continuation of PCT Application No. PCT/JP2013/077822, filed on Oct. 11, 2013, which is based upon and claims the benefit of priority from Japanese Patent Application No. 2012-232197 filed on Oct. 19, 2012. The contents of those applications are incorporated herein by reference in their entireties.

### REFERENCE SYMBOLS

1: Transparent plate having an adhesive layer

2: Display device

3: Support film

5 and 8: Laminate

10: Protective plate (transparent plate)

10a: Upper side of protective plate (surface facing adhesive layer)

11: Cover material

11a: Upper side of cover material

13: Intermediate material

13a: Upper side of intermediate material

13b: Peripheral end face of intermediate material (cut edge)

13A: Intermediate material film

14 and 14A: Adhesive layer

14b: Peripheral end face of adhesive layer (cut edge)

14g: Peripheral portion of adhesive layer

14h: Inner portion of adhesive layer

15: Notched portion

16: Protective film

16b and 4: Peripheral end face of protective film (cut edge)

16e and 4e: Peripheral portion of protective film

17: Adhesive material for cover material

19: Adhesive material for intermediate material

21: Adhesive material for support film

36: Supporting surface material

50: Display panel

What is claimed is:

1. A transparent plate having an adhesive layer, which comprises
a transparent plate;
a cover material formed on a peripheral portion of a surface of the transparent plate and having a notched portion on an upper side thereof;
an adhesive layer formed in a region enclosed by the transparent plate and the cover material and on a partial region of the cover material such that the adhesive layer has a peripheral end face on the cover material, wherein the peripheral end face coincides with a position of the notched portion in a planar direction of the transparent plate; and
a peelable protective film formed on the adhesive layer and having a peripheral end face such that the peripheral end face of the protective film is flush with the peripheral end face of the adhesive layer coinciding with the position of the notched portion.

2. The transparent plate having an adhesive layer according to claim 1, wherein the peripheral end faces of the protective film and the adhesive layer are flush with each other.

3. The transparent plate having an adhesive layer according to claim 1, further comprising an intermediate material, the intermediate material formed between the upper side of the cover material and the adhesive layer, the intermediate material having a peripheral end face being flush with the peripheral end faces of the adhesive layer and the protective film coinciding with the position of the notched portion.

4. A display device comprising:
a display panel;
a transparent plate bonded to the display panel via an adhesive layer and having a wider area than an effective pixel region of the display panel; and
the transparent plate having an adhesive layer defined in claim 1 with the protective film peeled therefrom, the transparent plate being bonded to the display panel such that the adhesive layer is brought into contact with the display panel.

5. A process for producing a transparent plate having an adhesive layer, comprising:
laminating a cover material on a peripheral portion of a surface of a transparent plate;
forming a seal portion on the cover material;
supplying a curable resin composition to a region enclosed by the surface of the transparent plate, the cover material and the seal portion;
laminating a protective film on the curable resin composition;
curing the curable resin composition to form an adhesive layer after laminating the protective film thereon; and
cutting off at least one part of a peripheral portion of the protective film and at least one part of a peripheral portion of the adhesive layer and removing at least one part of the seal portion.

6. A process for producing a display device, comprising:
laminating a cover material on a peripheral portion of a surface of a transparent plate;
forming a seal portion on the cover material;
supplying a curable resin composition to a region enclosed by the surface of the transparent plate, the cover material and the seal portion;
laminating a protective film on the curable resin composition;
curing the curable resin composition to form an adhesive layer after laminating the protective film thereon;
cutting off at least one part of a peripheral portion of the protective film and at least one part of a peripheral portion of the adhesive layer and removing at least one part of the seal portion;
peeling the protective film after removing the at least one part of the seal portion; and
carrying out bonding such that a display panel is brought into contact with the adhesive layer with the protective film peeled therefrom.

7. The process according to claim 6, further comprising making a slit in the protective film after removing the at least one part of the seal portion, such that the protective film is peelable so as to start peeling at the slit.

8. A transparent plate having an adhesive layer comprising:
a transparent plate;
a light-shielding printed portion formed on a peripheral portion of a surface of the transparent plate;
a cover material formed on the light-shielding printed portion;
an adhesive layer made of a homogenous material, formed in a region enclosed by the transparent plate and the cover material and on a partial region of the cover material without having a gap with the cover material;
a peelable protective film formed on the adhesive layer; and
the cover material and the light-shielding printed portion having inner end faces, respectively, such that the inner end face of the cover material is formed on the outer side of the inner end face of the light-shielding printed portion by a distance of from d to 3d in a planar direction of the transparent plate wherein the adhesive layer has a thickness of d.
